(19) United States
(12) Patent Application Publication
(10) Pub. No.: US 2025/0187266 A1
(43) Pub. Date: Jun. 12, 2025

(54) COMPACTING BUILD MATERIAL

(71) Applicant: Peridot Print LLC, Palo Alto, CA (US)

(72) Inventors: Marc GARCIA GRAU, Sant Cugat Valles (ES); Ramon DURAN LLUCIA, Sant Cugat del Valles (ES); Sergi CULUBRET CORTADA, Sant Cugat del Valles (ES); Sergio PUIGARDEU ARAMENDIA, Sant Cugat del Valles (ES); Jorge DIOSDADO BORREGO, Sant Cugat del Valles (ES); Albert RODRIGUEZ FERNANDEZ, Sant Cugat del Valles (ES)

(73) Assignee: Peridot Print LLC, Palo Alto, CA (US)

(21) Appl. No.: 18/842,752

(22) PCT Filed: Mar. 2, 2022
(86) PCT No.: PCT/US2022/018533

§ 371 Date: Aug. 29, 2024

(51) Int. Cl. B29C 64/218; B29C 64/227; B33Y 10/00; B33Y 30/00

(52) U.S. Cl. CPC B29C 64/218; B29C 64/227; B33Y 10/00; B33Y 30/00

(57) ABSTRACT

An additive manufacturing apparatus is disclosed. The additive manufacturing apparatus, comprises a build platform; a build material depositor to deliver build material layer-by-layer onto the build platform, wherein the build material depositor is to deliver a first plurality of layers of build material to form a foundation, and a second plurality of layers of build material on top of the first plurality of layers of build material, wherein portions of build material in the second plurality of layers of build material are to be selectively solidified to form a three-dimensional object; and a build material compacting mechanism to compact the first plurality of layers of build material that are formed on the build platform prior to delivery of the second plurality of layers of build material, such that the first plurality of layers of build material are caused to have a higher density than the second plurality of layers of build material. A method and a machine-readable medium are also disclosed

### BACKGROUND

Additive manufacturing systems can be used to generate three-dimensional objects on a layer-by-layer basis, for example by causing the solidification of some parts of successive layers of build material.

### BRIEF DESCRIPTION OF DRAWINGS

Examples will now be described, by way of non-limiting example, with reference to the accompanying drawings, in which:

FIG. 1 is a schematic illustration of an example of an apparatus for compacting build material;

FIG. 2 is a schematic illustration of a further example of an apparatus for compacting build material;

FIG. 3 is a flowchart of an example of a method of compacting build material;

FIG. 4 is a schematic illustration of a further example of an apparatus for compacting build material;

FIG. 5 is a flowchart of a further example of a method of compacting build material; and

FIG. 6 is a schematic illustration of an example of a processor in communication with a machine-readable medium.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc, or a metallic build material, for example.

In some examples, selective solidification is achieved through directional application of energy, for example using a laser or electron beam which results in solidification of build material where the directional energy is applied. In other examples, print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern.

According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink, such as inks commercially known as CE039A and CE042A available from HP Inc.

In other examples, coalescence may be achieved in some other manner.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A detailing agent (also termed a “coalescence modifier agent” or “coalescing modifier agent”) may, in some examples, have a cooling effect. In some examples, the detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a modifying agent, and/or as a print agent to provide a particular color for the object. While, in some examples, various agents as discussed above may be used with plastics build material, in other examples, binding agent (sometimes referred to as binder) may be used with metallic build material.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

Once layers of build material have been caused to solidify or coalesce, the resulting part/three-dimensional object may be processed further, for example to remove any non-solidified powder, and to clean the object.

In other additive manufacturing techniques, such as techniques involving metallic build material, binder agent may be applied to successive layers of build material to define a shape of a three-dimensional object to be formed. The volume (i.e., layers) of build material may then undergo a curing process in which the build material is heated to a temperature exceeding the curing temperature of the binder agent for a sufficient duration thereby curing the binder agent. In some examples, the curing process may involve the use of a vacuum source to extract fluids (e.g., air and solvents) from a chamber in which the three-dimensional object is to be generated. Use of the vacuum source can cause localized compression of build material, especially in the lower layers of build material, leading to a non-uniform density of build material over the extent of a layer or multiple layers. In some cases, such a difference in build material density can lead to defects (e.g., cracks and/or week regions) forming in three-dimensional objects being generated.

According to examples disclosed herein, a layer of build material, or multiple layers of build material, are subjected to some degree of compacting, in order to more uniformly compress or compact the build material so as to increase a density (e.g., a packing density) of the build material over the extent of the layer(s). In additive manufacturing processes, the first layers of build material that are formed (i.e., those layers formed at the bottom of the plurality of layers) may be referred to as foundational layers or sacrificial layers. These foundational layers may form a base or foundation on which further layers of build material are formed and that are used to generate the three-dimensional objects. Build material in the foundational layers themselves may not form part of the three-dimensional objects. By compacting the lower, foundational layers, and particularly compacting the foundational layers to a greater extent than the upper layers used to generate the three-dimensional objects, there is a reduced likelihood of defects (e.g., cracks or weak regions) forming in the three-dimensional objects. For example, when the curing process is performed, the operation of the vacuum source is likely to have less of an effect on those layers of build material that have already been compacted, thereby reducing the likelihood of defects forming in the three-dimensional object.

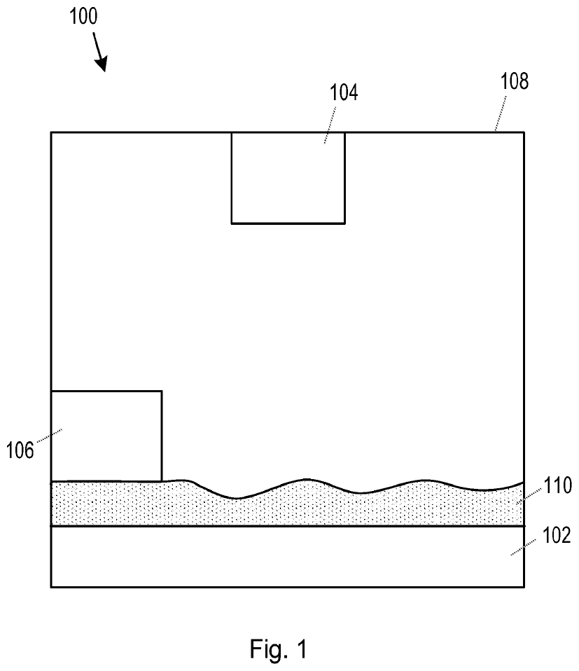

Compacting the build material may be achieved in various ways, as described below with reference to the drawings. FIG. 1 is a schematic illustration of an example of an apparatus 100 which can be used for compacting build material. Specifically, in FIG. 1, the apparatus 100 comprises part of an additive manufacturing apparatus comprising a build platform 102, a build material depositor 104 and a build material compacting mechanism 106. In this example, the build platform 102, the build material depositor 104 and the build material compacting mechanism 106 are located within and/or around a chamber 108, sometimes referred to as a build chamber, within which the layers of build material formed and the three-dimensional objects are generated. In other examples, however, other arrangements may be used.

The build material depositor 104 is arranged to deliver build material 110 onto or adjacent to the build platform 102. While the build material depositor 104 is located centrally above the build platform 102 in this example, in other examples, the build material depositor may take a different form and/or be located differently. The build material depositor 104 may, in some examples, deposit build material 110 into one particular region on the build platform 102, and another component may be used to spread the build material (e.g., uniformly, or approximately uniformly) across the build platform. In other examples, however, the build material depositor 104 may deposit and spread the build material 110 across the build platform 102. Depositing build material 110 onto the build platform 102 or onto a previously formed layer of build material may involve delivering a volume of build material, for example in a pile, or sprinkling the build material in a pile or over some or all of the build platform or a previously formed layer of build material. The build material depositor 104 is arranged to deliver build material to form a first plurality of layers of build material 110 to form a foundation (e.g., foundational or sacrificial layers), and a second plurality of layers of build material on top of the first plurality of layers of build material. Portions of build material 110 in the second plurality of layers of build material are to be selectively solidified to form a three-dimensional object. Thus, as noted above, the build material 110 used to form the first plurality of layers of build material may not be used to form the three-dimensional object.

The build material compacting mechanism 106 is arranged to compact the build material forming the first plurality of layers of build material 110 that are formed on the build platform 102 prior to delivery of the second plurality of layers of build material, such that the first plurality of layers of build material are caused to have a higher density than the second plurality of layers of build material. In some examples each layer of build material may be compacted after it has been formed before the next layer is formed. In other examples, all of layers in the first plurality of layers of build material may be formed and the compacting may then be performed. As discussed above, compacting the first plurality of layers of build material 110 (i.e., the foundational layers) to a greater extent than the second plurality of layers of build material, which may be used to generate a 3D object or multiple 3D objects, can improve the foundation and can reduce the likelihood that localized compacting of build material occurs when certain processing techniques (e.g., curing) are performed. This can, in turn, reduce the likelihood that manufacturing defects such as cracks and weakened portions occur in the three-dimensional objects being generated.

The build material compacting mechanism 106 may, in some examples, move relative to the build platform 102 so as to apply a force and/or pressure to a layer of build material 110 formed on the print bed. In one example, the build material compacting mechanism 106 may comprise a roller capable of moving (e.g., rolling) over the build platform 102 and compressing the build material 110 as it moves. In other examples, as discussed below, the build material compacting mechanism 106 and/or the build platform 102 may be moved relative to one another, thereby reducing their relative separation, and compacting the build material 110 formed on the build platform.

In some examples, such as the example shown in FIG. 1, the build material compacting mechanism 106 may comprise a roller. Once a layer of build material 110 has been formed, the roller 106 may be moved (e.g., rolled) over the build platform 102 to compact the layer of build material, before a further layer of build material is formed. In other examples, rather than rolling over the layer of build material 110, the build material compacting mechanism (e.g., the roller 106) may be moved laterally (e.g., translated parallel to the build platform) over the build platform 102 into a plurality of positions and, at each position, the build material compacting mechanism is moved up and down (away from and towards the build platform 102) to compact a portion of the build material, as discussed in greater detail below.

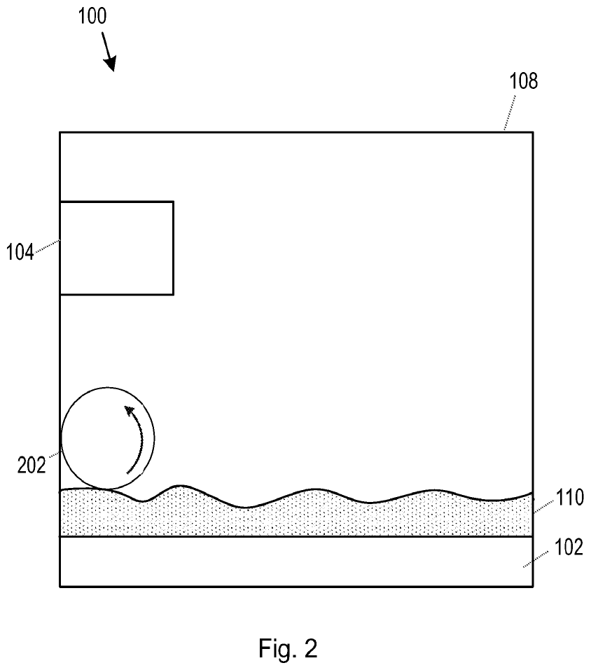

In the example shown in FIG. 1, the build material compacting mechanism 106 and the build material depositor 104 are separate components. In other examples, however, the build material compacting mechanism 106 may comprise the build material depositor 104 (or vice versa). In other words, a single component may be used both to deliver build material 110 onto the build platform 102 and also to compact the first plurality of layers of build material. An example of the apparatus 100 which the build material compacting mechanism 106 comprises a roller is shown in FIG. 2.

In the example shown in FIG. 2, the apparatus 100 includes a build chamber 108 having a build platform 102 upon which layers of build material 110 may be formed. In this example, build material may be deposited by the build material depositor 104, and a roller 202 both spreads the build material over the build platform 102 to form a layer, and also serves as the build material compacting mechanism 106. The act of spreading the build material to form a layer using the roller 202 will compact the build material to some degree. In some examples, the build material compacting mechanism 106 comprises a roller (i.e., the roller 202) to spread deposited build material 110 over the build platform 102 during a build material depositing process. In one example, the roller 202 rotates as it spreads build material 110 over the build platform 102. The roller 202 may rotate in a first direction (e.g. the direction indicated by the arrow shown in FIG. 2) as it is moved/translated over the build platform 102, and this may help to spread the build material 110 over the build platform while causing some compaction of the deposited build material. This may be referred to as counter-rotating the roller, and the roller may rotate in a direction opposite to the direction of movement over the build platform.

To assist with compacting the build material, as explained in the example below, the layers that are to be compacted (e.g. the foundational layers) may be formed with a larger volume of build material than those layers that are not to form the compacted foundational layers. Thus, a greater volume of build material may be deposited and spread over the build platform or the previously formed layer to form the foundational layers than is used to form layers above the foundational layers. In this way, as the roller moves over the build platform, it can have a significant compacting effect on the build material, rather than merely spreading and levelling the build material. A greater compacting effect can be achieved by changing the direction of rotation of the roller. Thus, once a defined amount of build material 110 has been deposited and spread over the build platform 102 (e.g., by rotating the roller in the first direction, such as the counter rotating direction while moving it over the build platform), the roller 202 may be rotated in a second direction (e.g., opposite to the direction indicated by the arrow in FIG. 2, or the non-counter rotating direction) as it is moved over the build platform, and this may cause further compacting of the of build material against the build platform (or against a previously compacted layer of build material). Thus, the roller 202 is arranged to be in contact with, and be moved over, the first plurality of layers of build material 110 as the roller rotates, to compact each of the first plurality of layers of build material as they are formed. In some examples, the roller 202 may perform a first pass over the build platform while rotating in the first direction (e.g., to spread the build material) and perform a second pass over the build platform while rotating in the second direction (e.g., to further compact the build material).

In one example of a compacting process using the apparatus 100 of FIG. 2, the roller 202 may be positioned relative to the build platform 102 with a defined separation based on the intended depth or thickness of a layer of build material 110 to be formed. For example, the separation between the roller 202 and build platform 102 may be based on the intended depth of a layer of build material that is to be formed above the foundational layers (e.g. a layer to be used to form a three-dimensional object. The depth of such a layer may, in an example, be 8 millimeters (mm). As noted above, for each of the foundational layers, the volume of build material 110 used to form each layer may be greater than the volume used to form the layers above the foundational layers. For example, the volume of build material used to form each foundational layer may be sufficient to provide a layer, prior to compaction, having a depth or thickness of around 9.5 mm. As the roller 202 is moved (e.g., rolled) over the deposited build material, build material is compacted to a thickness of around 8 mm, such that the resulting foundational layer has a density that will be greater than the density of the non-foundational layers formed above the foundational layers. The depth/thickness of each of the layers of build material may be determined by calculations, simulations and/or experimentation.

In either of the examples shown in FIGS. 1 and 2, in which the build material compacting mechanism 106 comprises a roller, the roller is arranged to be in contact with or come into contact with, and be moved over, each of the first plurality of layers of build material 110 as the roller rotates, to compact each layer in the first plurality of layers of build material. Thus, after a layer of build material has been formed, it is compacted. Compacting of the first plurality of layers of build material 110 may be performed on a layer-by-layer basis. For example, a first volume of build material 110 may be deposited onto the build platform 102 (or in some cases onto a platform next to the build platform), then spread over the build platform (or over a previously formed layer of build material) to form a layer of build material, then compacted by the build material compacting mechanism 106, then a second volume of build material may be deposited, spread to form a layer, and compacted, then a third volume of build material may be deposited, spread to form a layer, and compacted, and so on. This may be repeated until a defined/intended number of layers of build material (e.g., those layers that are to form the foundational layers) have been formed and compacted.

As noted briefly above, in some examples, the build material compacting mechanism 106, which may comprise a roller such as the roller 202, may be used to compact a first region of a layer of build material 110, before being moved to a new position to compact a second region of the layer of build material, then moved to a new position to compact third region of the layer of build material, and so on until the entire layer of build material has been compacted. Compacting the build material in this way may be achieved by reducing the separation between the build material compacting mechanism 106 (e.g., the roller) and the build platform 102, for example by moving the build material compacting mechanism down and/or the build platform up.

Put another way, the build material depositor 104 (e.g., the roller 202) and the build platform 102 may be moveable relative to one another. Compacting of the first plurality of layers of build material 110 may be caused by compacting the first plurality of layers of build material between the build material depositor 104 (which may also comprise the build material compacting mechanism 106) and the build platform 102. In other examples, compacting of the first plurality of layers of build material 110 may be caused by compacting the first layers of build material between the build material compacting mechanism 106 and the build platform 102. In some examples, the build material depositor 104 may be moveable between a plurality of positions relative to the build platform. For example, the build material depositor 104 (which may also comprise the build material compacting mechanism 106) may move over the surface of the build platform 102, for example from one side to another. In each of the plurality of positions, relative movement reducing a distance between the build material depositor 104 and the build platform 102 may cause compacting of the first plurality of layers of build material.

An example of such a build material compacting process may involve depositing a volume of build material 110 onto the build platform 102 and spreading the volume of build material over the build platform. The volume of build material deposited onto the build platform 102 is sufficient to form a layer having a thickness or depth slightly more (e.g., approximately 1.5 mm more) than the separation between the platform and the build material compacting mechanism 106 (e.g., a roller). The separation may, for example, be 8 mm, and in an example, the volume of build material may form a layer, prior to compaction, of around 9.5 mm in depth. The additional depth of the layer aids the compaction of the build material in the layer.

The build material compacting mechanism 106 is moved into a first (e.g., initial) lateral position relative to the build platform 102, for example at the edge of the build platform and, in this example, the build platform is then raised (i.e., lifted up) by towards the build material compacting mechanism. The amount by which the build platform is lifted may depend on characteristics of the build material, such as the average grain size of the build material, and in one example, the build platform is lifted by around 10 μm. In other examples, the build platform may be lifted by 5 μm, 20 μm, 50 μm, or the like. Lifting the build platform 102 decreases the separation between build platform and the build material compacting mechanism 106, thereby causing the build material in the first layer of build material and the first supplemental layer of build material to be compacted by the amount that the build platform is lifted (in this case, 10 μm). The build platform 102 is then lowered (e.g., back to its original, lowered position) by 10 μm, and the build material compacting mechanism 106 is moved to a new (e.g., second) lateral position, which may for example be a few millimeters along the length of the build platform 102. The lifting and lowering of the build platform 102 by the same amount (e.g., 10 μm) is repeated, and the build material compacting mechanism 106 is moved into another new lateral position (e.g., a third lateral position), and the lifting and lowering of the build platform is repeated again. The incremental movement of the build material compacting mechanism 106 is repeated over the extent of the build platform 102 or a total of n positions, where n is calculated by dividing the total length of the build platform by the width of the region of build material 110 compacted each time the build platform is lifted.

Once all of the build material in the layer has been compacted by the intended amount (e.g., 10 μm in this example), the build material compacting mechanism 106 may be returned to its initial position, the build platform 102 is raised to a new vertical position (e.g., raised by 10 μm), and the compacting process is repeated (e.g., lifting the build platform by 10 μm, and lowering the build platform by 10 μm with the build material compacting mechanism in each position). In this example, this loop is repeated 150 times such that, in total, the build material in the layer is compacted by 1.5 mm (i.e., 150×10 μm=1.5 mm) which, in this example, is equal to the additional depth of the layer of build material formed using the deposited build material. This may then be repeated for a second layer of build material, and for subsequent layers of build material. In other examples, the number of times that the loop is repeated may be different, and this may depend on the depth of each layer of build material and/or the distance that the build platform is lifted and lowered during each iteration.

It will be understood that the depth of each layer of build material formed on the build platform 102 and, therefore, the amount by which the build platform is lifted and lowered during the compacting process may be varied depending on the amount of build material used, the size of the build material compacting mechanism 106 and the amount of compacting intended.

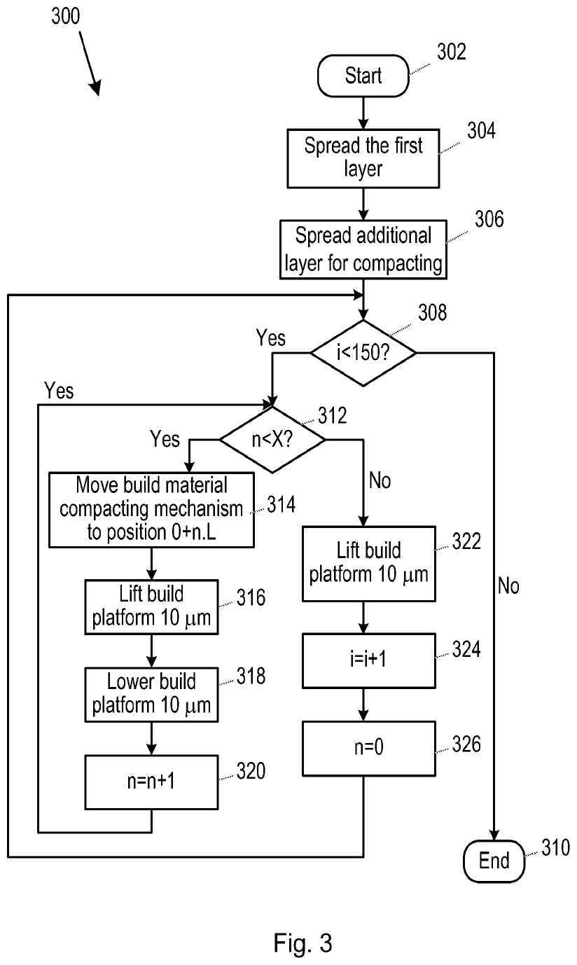

FIG. 3 is a flowchart showing, in greater detail, an example of the compacting process 300 described above. The process 300 begins at block 302, after a volume of build material has been deposited onto the build platform 102. At block 304, the volume of build material is spread over the build platform 102 to form a first layer of build material. At block 306, a further (i.e., supplemental) volume of build material is deposited onto and spread over the first layer, to form a supplemental layer of build material. The supplemental layer of build material, which in one example may have a depth of around 1.5 mm, is to be used to aid the compaction of the first layer of build material. In some examples, blocks 302 and 304 may be replaced by a single block in which a larger volume of build material is deposited and spread to form a layer of build material having a depth that is greater than the separation between the platform and the build material compacting mechanism 106. At block 308, a check is performed to determine whether the full depth of build material in the supplemental layer (i.e., 1.5 mm in this example) has been compacted, by determining whether the number of times, i, that the build platform has been moved closer to the build material compacting mechanism 106, is less than a defined number of times which, in this example, is 150). If it is determined that/is not less than 150, then it can be determined that the compacting process for the first layer of build material has been completed, and the process ends at block 310. However, if it is determined that i<150, then the process continues to block 312 where a determination is made as to whether or not the build material compacting mechanism 106 has been moved (i.e., laterally) over the full extent of the build platform 102. As noted above, first compaction of build material is performed with the build material compacting mechanism 106 in a first lateral position relative to the build platform (e.g. at an edge of the build platform). The build material compacting mechanism 106 is moved incrementally across the build platform for each subsequent compaction, into a second lateral position, a third lateral position, and so on. Block 312 involves determining whether the number of times, n, that the build material compacting mechanism has been moved to a new lateral position over the build platform is less than the total number of lateral positions, X, over the build platform that the build material compacting mechanism will be moved to. If it is determined at block 312 that n<X, then the build material compacting mechanism 106 is moved to its next position (0+n·L) at block 314. At block 316, the build platform 102 is lifted by 10 μm, towards the build material compacting mechanism 106, which causes compaction of the build material between the build material compacting mechanism 106 and the build platform. The build platform 102 is then lowered by 10 μm, at block 318. The number n is increased by 1 at block 320, and the process returns to block 312.

If it is determined at block 312 that n is not less than X (i.e., that the build material compacting mechanism 106 has been moved into all of its possible positions across the extent of the build platform 102), then the process proceeds to block 322, where the build platform is lifted by 10 μm. The value of i is increased by one at block 324 and the value of n is reset to 0 at block 326. The process then returns to block 308, where the next series of lifting and lowering of the build platform begins.

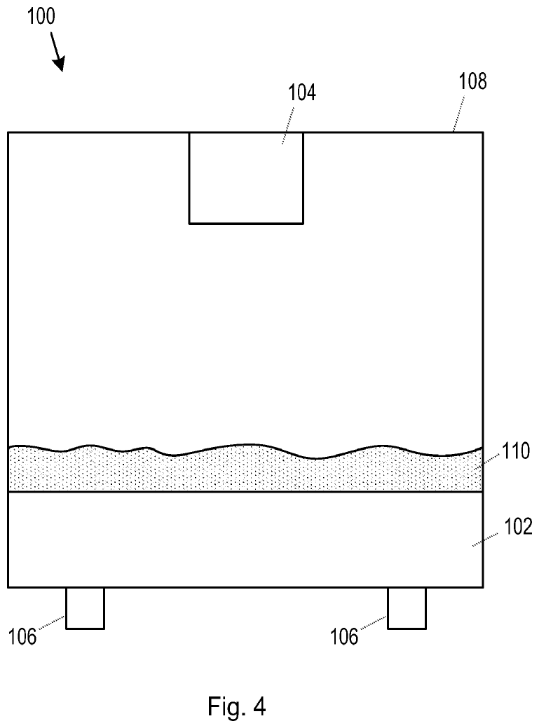

In the examples described above, the build material compacting mechanism 106 comes into contact with the build material 110 to cause it to compact; in one example, a roller compacts the build material as it rolls over the first layer and the supplemental layer of build material, and in another example, the build material compacting mechanism 106 (e.g., a roller) compacts the build material in the first layer and the supplemental layer one portion at a time, as build platform is moved up towards the build material compacting mechanism. In a further example, compacting the build material 110 may be achieved using a build material compacting mechanism 106 that does not itself come into contact with the build material. FIG. 4 is a schematic illustration of an apparatus 100 according to such an example. In this example, the apparatus 100 comprises the build platform 102 and the build material depositor 104 to deposit build material 110 onto the build platform. The build material compacting mechanism 106, in this example, may comprise a vibration device. In some examples, multiple vibration devices may be provided to function together to provide the build material compacting effect. The vibration device 106 is in contact with the build platform 102, and is capable of causing the build platform to vibrate. In this example, to vibration devices 106 are positioned underneath the build platform 102 (e.g., on a surface of the build platform opposite to a surface on which the build material 110 is deposited). Compacting the layers of build material 110 using vibration may be performed on a layer-by-layer basis.

In some examples, the vibration devices 106 may comprise pneumatic vibration devices while, in other examples, other types of vibration devices may be used, such as piezoelectric vibration devices. In examples where multiple vibration devices 106 are used, all of the vibration devices may be of the same type, or a variety of different vibration device types may be used. While the example shown in FIG. 4 includes two vibration devices 106, other examples may involve the use of more than two vibration devices and, in some examples, a single vibration device may be used. Similarly, the position of the vibration devices may vary from those shown in FIG. 4. For example, the vibration devices may be positioned on a side or on sides of the build platform 102, or may be located within the build platform.

The vibration devices 106 may be arranged to cause vibration of the build platform 102 in a direction (or in multiple directions) parallel to the surface of the build platform on which the build material 110 is deposited (sometimes referred to as the x-y plane or x-or y-directions) and, in some examples, the vibration devices may be arranged to cause vibration of the build platform in a direction normal to the surface of the build platform (sometimes referred to as the z-direction). Thus, the vibration device 106 may cause the build platform to vibrate in a direction perpendicular to a surface of the build platform on which build material 110 is to be deposited. Vibrating the build platform 102 in the z-direction may have a greater compacting effect on the layers of build material 110 than vibrations in the x- and y-directions. However, vibrations in the x- and y-directions may further assist with spreading the build material 110 more uniformly over the build platform 102. In some additive manufacturing apparatuses, a channel or trench may be formed along a side of the build platform 102 or a long multiple sides (e.g., around the perimeter of the build platform), forming a separation between the build platform and walls of the build chamber 108. Vibrations in the x-and y-directions may further cause build material 110 to fall into and fill the channel(s), further improving the uniformity of the layers of build material formed on the build platform.

In some examples, a compacting process may be performed (e.g., the vibration devices 106 may be operated) after each of the foundational layers has been formed on the build platform 102 or on a previously-formed layer of build material. Thus, in such examples, just the foundational layers may be compacted using a compacting process described herein. In other examples, however, a compacting process may be performed in respect of other layers of build material formed during the additive manufacturing process, for example those layers used for generating the three-dimensional object(s). In some examples, all of the layers of build material may be compacted to some extent using a technique disclosed herein (e.g., using the vibration devices 106), and the foundational layers of build material may be compacted to a greater extent than the layers of build material formed on top of the foundational layers. In some examples, a compacting technique may be used to compact a subset of the layers of build material formed during the additive manufacturing process, such as every other layer, or one layer out of every three layers formed, for example. In some examples, a sacrificial layer or layers of build material may be formed between layers of build material that are used to generate the three-dimensional objects during an additive manufacturing process. The sacrificial layers may be layers of build material that are not used to form the three-dimensional objects, and may be discarded after the completion of the additive manufacturing process, for example. In some examples, a compacting process may be applied to a sacrificial layer or sacrificial layers of build material formed between the three-dimensional objects.

In some examples, multiple compacting processes of those disclosed herein may be applied and used to compact a layer of build material. Combining multiple compacting techniques may improve the compacting effect, resulting in a layer of build material having a greater density/packing density. Moreover, performing multiple compacting processes at the same time can reduce the time taken to compact a layer of build material.

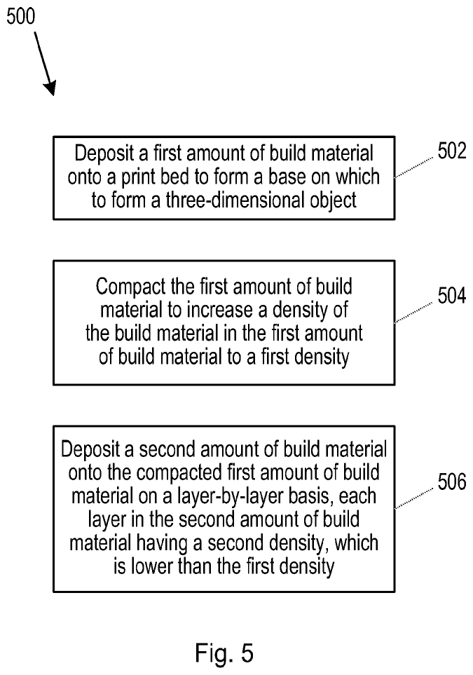

Examples of the present disclosure also relate to a method, such as a method of compacting build material. FIG. 5 is a flowchart of an example of such a method 500. The method 500 comprises, at block 502, depositing a first amount of build material 110 onto a print bed (e.g., the build platform 102), the first amount of build material to form a base on which to form a three-dimensional object. The base formed by the first amount of build material may comprise or be similar to the first plurality of layers of build material that form the foundation (e.g., the foundational layers). The first amount of build material 110 may be deposited by the build material depositing 104 in some examples.

At block 504, the method 500 comprises compacting the first amount of build material 110 to increase a density of the build material in the first amount of build material to a first density. Compacting the first amount build material may be achieved using a technique or multiple techniques of those disclosed herein, and may be performed using the build material compacting a mechanism 106 described above.

The method 500 comprises, at block 506, depositing a second amount of build material 110 onto the compacted first amount of build material, the second amount of build material being deposited on a layer-by-layer basis, wherein portions of second amount of build material are to be selectively solidified to form the three-dimensional object. In other words, the second amount of build material may comprise or be similar to the second plurality of layers of build material discussed above.

Each layer in the second amount of build material has a second density, which is lower than the first density. In other words, the first amount of build material is compacted to a greater extent than the second amount of build material. For example, the act of compacting the first amount of build material to a greater extent than the second amount of build material is compacted may cause the first density to be greater than the second density. In this way, the more compact layers (e.g., the lower layers) in the first amount of build material can form a strong foundation upon which the three-dimensional objects may be generated, thereby reducing the likelihood of manufacturing defects (e.g., cracks) forming in the three-dimensional objects.

Compacting the first amount of build material may be achieved using the techniques disclosed herein. In some examples, compacting the first amount of build material may comprise applying a vibration to the print bed (e.g., using the vibration devices 106 as shown in the example of FIG. 4).

In other examples, compacting the first amount of build material may comprise rolling a roller (e.g., the roller 202) over a surface of the first amount of build material (as shown in the example of FIG. 3).

In other examples, compacting the first amount of build material may comprise performing a process similar to that described above with reference to FIG. 3. For example, compacting the first amount of build material may comprise positioning a compacting surface above a first portion of the print bed. The compacting surface may, for example, comprise a surface of the build material compacting mechanism 106, such as the roller 202. The compacting process may then involve moving the print bed and/or the compacting surface so as to temporarily reduce a distance between the compacting surface and the first portion of the print bed. The process of reducing the distance between the compacting surface and the first portion of the print bed may apply a compressive/compacting force on the build material. Compacting the first amount build material may then comprise positioning a compacting surface above a second portion of the print bed. The same compacting surface may be used to compact the build material positioned at both the first portion and the second portion, or different compacting surfaces may be used. The compacting process may then involve moving the print bed and/or the compacting surface so as to temporarily reduce a distance between the compacting surface and the second portion of the print bed. This process may be repeated for a third position, a fourth position, and so on, until the build material has been compacted over the extent of the print bed.

In some examples, as noted above, depositing a first amount of build material onto a print bed may comprise depositing build material to form a plurality of layers of build material. In such examples, compacting the first amount of build material may comprise compacting each layer of the plurality of layers, before a subsequent layer of build material is formed. This may be performed in respect of each layer of build material formed during the additive manufacturing process, or in respect of a subset of the layers formed.

Similarly, depositing a second amount of build material onto a print bed may, in some examples, comprise depositing build material to form a plurality of layers of build material. In such examples, the method 500 may further comprise compacting a layer of build material in the second amount of build material to increase a density of the build material in the second amount of build material. Thus, build material in both the first amount of build material and the second amount build material may be compacted to increase its density.

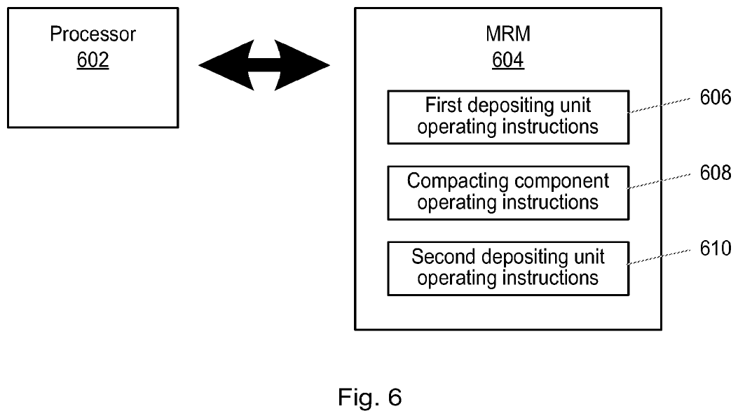

Examples of the present disclosure also relate to a machine-readable medium. FIG. 6 is a schematic illustration of an example of a processor 602 in communication with a machine-readable medium 604. According to examples, the machine-readable medium 604 comprises instructions which, when executed by the processor 602, cause the processor to perform various processes, such as the processes defined in the blocks of the method 500 discussed above. For example, the machine-readable medium 604 may comprise instructions (e.g., first depositing unit operating instructions 606) which, when executed by the processor 602, cause the processor to operate a depositing unit (e.g., the build material depositor 104) to deposit build material to form foundational layers of build material 110 on a build platform 102 of an additive manufacturing apparatus. The machine-readable medium 604 may further comprise instructions (e.g., compacting component operating instructions 608) which, when executed by the processor 602, cause the processor to operate a compacting component to cause the foundational layers of build material to be compacted, thereby increasing a packing density of build material in the foundational layers. The machine-readable medium 604 may further comprise instructions (e.g., second depositing unit operating instructions 610) which, when executed by the processor 602, cause the processor to operate the depositing unit to deposit build material to form further layers of build material on the compacted foundational layers of build material. Build material in the further layers of build material may be selectively solidified to form a three-dimensional object. The packing density of build material in the foundational layers is larger than a packing density of build material in the further layers of build material. This difference in the packing density of the build material is due to the increased amount of compacting provided to the build material in the foundational layers relative to the further layers of build material (which may not be compacted or may be compacted to a lesser extent).

The machine-readable medium 604 may further comprise instructions which, when executed by the processor 602, cause the processor to operate the compacting component to spread the deposited build material over the build platform, prior to causing the foundational layers of build material to be compacted. In this way, the compacting component (e.g., a roller) may serve both to spread the build material and to compact the build material.

Various examples disclosed herein provide a mechanism by which some layers of build material used in an additive manufacturing apparatus can be compacted to a greater extent than other layers of build material, thereby forming a volume of build material to form a base or foundation having a relatively greater density than layers of build material to be formed on top of the base/foundation from which three-dimensional objects are to be generated during the additive manufacturing process. By forming the three-dimensional objects on a base having a relatively greater density, there is a reduced likelihood of manufacturing defects occurring in the three-dimensional object.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. An additive manufacturing apparatus, comprising:
a build platform;
a build material depositor to deliver build material layer-by-layer onto the build platform, wherein the build material depositor is to deliver build material to form a first plurality of layers of build material to form a foundation, and a second plurality of layers of build material on top of the first plurality of layers of build material, wherein portions of build material in the second plurality of layers of build material are to be selectively solidified to form a three-dimensional object; and
a build material compacting mechanism to compact the first plurality of layers of build material that are formed on the build platform prior to delivery of the second plurality of layers of build material, such that the first plurality of layers of build material are caused to have a higher density than the second plurality of layers of build material.

2. An additive manufacturing apparatus according to claim 1, wherein the build material compacting mechanism comprises a roller to spread deposited build material over the build platform during a build material depositing process and to apply a force to the build material during a compacting process.

3. An additive manufacturing apparatus according to claim 2, wherein the roller is to be in contact with, and be moved over, the first plurality of layers of build material as the roller rotates, to compact the first plurality of layers of build material.

4. An additive manufacturing apparatus according to claim 1, wherein the build material depositor and the build platform are moveable relative to one another; and
wherein compacting of the first plurality of layers of build material is caused by compacting the first plurality of layers of build material between the build material depositor and the build platform.

5. An additive manufacturing apparatus according to claim 4, wherein the build material depositor is moveable between a plurality of positions relative to the build platform;
wherein, in each of the plurality of positions, relative movement reducing a distance between the build material depositor and the build platform causes compacting of the first plurality of layers of build material.

6. An additive manufacturing apparatus according to claim 1, wherein the build material compacting mechanism comprises a vibration device;
wherein the vibration device is in contact with the build platform, and is capable of causing the build platform to vibrate.

7. An additive manufacturing apparatus according to claim 6, wherein the vibration device is to cause the build platform to vibrate in a direction perpendicular to a surface of the build platform on which build material is to be deposited.

8. A method comprising:
depositing a first amount of build material onto a print bed, the first amount of build material to form a base on which to form a three-dimensional object;
compacting the first amount of build material to increase a density of the build material in the first amount of build material to a first density; and
depositing a second amount of build material onto the compacted first amount of build material, the second amount of build material being deposited on a layer-by-layer basis, wherein portions of second amount of build material are to be selectively solidified to form the three-dimensional object;
wherein each layer in the second amount of build material has a second density, which is lower than the first density.

9. A method according to claim 8, wherein compacting the first amount of build material comprises applying a vibration to the print bed.

10. A method according to claim 8, wherein compacting the first amount of build material comprises:
positioning a compacting surface above a first portion of the print bed;
moving the print bed and/or the compacting surface so as to temporarily reduce a distance between the compacting surface and the first portion of the print bed;
positioning a compacting surface above a second portion of the print bed; and
moving the print bed and/or the compacting surface so as to temporarily reduce a distance between the compacting surface and the second portion of the print bed.

11. method according to claim 8, wherein compacting the first amount of build material comprises rolling a roller over a surface of the first amount of build material.

12. A method according to claim 8, wherein depositing a first amount of build material onto a print bed comprises depositing build material to form a plurality of layers of build material; and
wherein compacting the first amount of build material comprises compacting each layer of the plurality of layers, before a subsequent layer of build material is formed.

13. A method according to claim 8, wherein depositing a second amount of build material onto a print bed comprises depositing build material to form a plurality of layers of build material;
wherein the method further comprises:
compacting a layer of build material in the second amount of build material to increase a density of the build material in the second amount of build material.

14. A machine-readable medium comprising instructions which, when executed by a processor, cause the processor to:
operate a depositing unit to deposit build material to form foundational layers of build material on a build platform of an additive manufacturing apparatus;
operate a compacting component to cause the foundational layers of build material to be compacted, thereby increasing a packing density of build material in the foundational layers; and
operate the depositing unit to deposit build material to form further layers of build material on the compacted foundational layers of build material;
wherein build material in the further layers of build material is to be selectively solidified to form a three-dimensional object; and
wherein the packing density of build material in the foundational layers is larger than a packing density of build material in the further layers of build material.

15. A machine-readable medium according to claim 14, further comprising instructions which, when executed by a processor, cause the processor to:
operate the compacting component to spread the deposited build material over the build platform, prior to causing the foundational layers of build material to be compacted.
